(19) United States
(12) Patent Application Publication
(10) Pub. No.: US 2004/0264981 A1
(43) Pub. Date: Dec. 30, 2004

(54) Wavelength monitoring and control system

(75) Inventors: Hongbin Zhang, Eatontown, NJ (US); R. Brian Jander, Freehold, NJ (US)

Correspondence Address: MOSER, PATTERSON & SHERIDAN L.L.P., 595 SHREWSBURY AVE, STE 100, FIRST FLOOR, SHREWSBURY, NJ, 07702, US

(73) Assignee: Tyco Telecommunications (US) Inc., Morristown, NJ

(21) Appl. No.: 10/873,324

(22) Filed: Jun. 22, 2004

Related U.S. Application Data
(60) Provisional application No. 60/482,572, filed on Jun. 25, 2003.

(51) Int. Cl. H04B 10/06

(52) U.S. Cl. 398/204

(57) ABSTRACT

A wavelength monitor and control system and method for a WDM optical transmission system is disclosed. The system comprises a heterodyne-based detection device with a real-time externally calibrated tunable laser.

### CROSS-REFERENCE TO RELATED APPLICATIONS

The present application claims the benefit of U.S. Provisional Application No. 60/482,572, filed Jun. 25, 2003, the disclosure of which is incorporated by reference herein.

### BACKGROUND OF THE INVENTION

Aspects of the present invention relate to optical telecommunication systems and particularly to a wavelength monitoring and control system and method for achieving performance optimization of an optical transmission system.

When the useable transmission bandwidth of a multi-wavelength, i.e., multi-terabit/s wavelength division multiplexed (WDM), transmission system is filled, traffic must be diverted to another system or the existing system must be upgraded to accommodate higher rates of data transmission.

One possible upgrade approach involves increasing the spectral efficiency (i.e., reducing the WDM channel spacing). In this case, for systems with very narrow channel spacing, for example, less than 35 GHz or so, the signal frequency must be carefully determined within a small range around a fixed frequency grid to mitigate inter-channel cross talk between neighboring channels. The frequency control grid might be an absolute grid, i.e., based on International Telecommunication Union (ITU) standards, or a relative grid determined, for example, by one or more interleaving filters or single channel filters.

Performance-based frequency adjustment algorithms are generally not satisfactory for positioning narrowly spaced channels. Currently available 10 Gb/s transponder systems derive the line transmitter optical channel from, for example, an externally modulated continuous wave distributed feedback (CW DFB) laser diode source. To reduce sparing costs associated with transponder circuit packs, the line transmitter of this known system has been designed such that several codes cover the C-band, each code being tunable over 200 GHz. Each transponder is selectable to a given 50 GHz ITU channel or utilizes a provisioning offset value, to any location within the specific 200 GHz tuning range.

Unlike certain commercially available transponders, in this particular set-up, a wavelength locker frequency control method is not designed into each line transmitter. Instead, during manufacture, each transmitter laser is calibrated over its individual tuning range and operating temperature range, allowing the laser to be provisioned within ±20 pm of any desired operating point.

To accommodate the need for system performance optimization during commissioning and to accommodate long-term aging effects of land-based system equipment and undersea system equipment (i.e., dry and wet plants), an adjustment algorithm based on far end channel Q performance is at times implemented to slowly and periodically fine-tune the operating DFB laser frequency. This adjustment algorithm approach, based on actual channel performance with slow frequency dithering, substantially obviated the design need for a wavelength locker.

This adjustment algorithm approach has proven somewhat successful for optimally controlling channel frequency as long as channels spacing are greater than about 40 or 50 GHz. However, practical experiments reveal that this approach may negatively affect overall performance if allowed to operate at narrower channel spacing.

In a transmission experiment performed on a transatlantic segment, it was determined that a 1 dB performance penalty resulted when one of two near neighbor 25 GHz channels was tuned toward the other measured channel by about 15 pm. In this case, the channel frequency detuning corresponded to about 7.5% of the channel spacing.

Thus, to obtain precise control and relative location of signals to each other and to noise, rejection filters may be required as channel spacing is decreased below about 50 GHz. Indeed, for current systems, especially those expected to reach full capacity at about 33 GHz channel spacing, a precision wavelength measure and control system is desired.

Such system should preferably measure and locate WDM signals with high relative or absolute accuracy. It would be desirable to have a system that employs a precision wavelength monitor and may require either a precision reference or special terminal architecture to establish an operating grid for the channel frequencies.

Optical channel monitor technology for WDM or dense WDM (DWDM) signals and networks are commercially available and may be classified into several groups. These include: 1) high-end optical spectrum analyzers (OSAs) based on scanning filters, e.g., tunable diffraction grating filters or tunable Fabry-Perot filters; 2) optical channel performance monitors based on optical wavelength splitters with diode array; and 3) precision wavelength meters based on the Michelson interferometer. It is desirable to have a precision aggregate-channel wavelength monitor.

For aggregated return-to-zero (RZ) and chirped RZ (CRZ) input signals, it is desirable to have high differential accuracy for locating signals as well as reasonably high absolute accuracy for positional measurement reporting.

Additionally, there is a desire to deploy equipment that does not require periodic re-calibration and can operate substantially continuously over the life of an optical telecommunication system. Given the performance penalties that arise from improperly positioned channel frequencies, both differential accuracy and the absolute accuracy should be less than ±3 pm to have less than 0.1 dB penalty when implementing 25 GHz channel spacing. The specified wavelength accuracy should be insensitive to the ambient temperature between 10° C. and 65° C., the atmospheric pressure and the humidity.

Current commercial products and technologies do not easily meet these requirements. Both OSA techniques and optical channel performance monitors do not have sufficient differential and absolute accuracy. For example, Ando's latest OSA model AQ6319 has about 10 pm wavelength accuracy; and BaySpec's IntelliGuard™ optical channel monitor has 15 pm wavelength accuracy.

In the case of a Michelson interferometer wavelength meter, sub-pm absolute accuracy is possible using a 633 nm Helium-Neon reference laser and stringent control of refractive index ratio between 633 nm and 1550 nm. However, the length of the Helium-Neon laser resonator and the refractive index ratio varies with temperature. So it would seem that the wavelength meter is suitable for lab conditions rather than long-term field deployment. For example, Ando's AQ6141 wavelength meter meets its stated specifications only when operating between 10° C. and 30° C. This narrow range does not exist in most, if not all, deployed systems.

### SUMMARY OF THE INVENTION

In accordance with one of several aspects of the present invention, there is provided a wavelength monitor system comprising a heterodyne-based detection device with a real-time externally calibrated tunable laser. Preferably, the tunable laser sweeps over substantially the entire wavelength range (C-band) and the beating signal is detected by a narrow bandwidth electrical receiver.

More preferably, the detection of the beating signal indicates that an input signal lies within a small region around the tunable laser.

In accordance with another aspect of the present invention, there is provided a wavelength measure and control system for an optical telecommunication system, comprising a first portion comprising a heterodyne detection device having a real-time externally calibrated tunable laser source for use as a local oscillator to produce a periodic wavelength reference, and a second portion that cooperates with the first portion for real-time wavelength calibration of an optical data signal.

Preferably, the second portion combines a periodic wavelength reference with a hydrogen cyanide (HCN) gas reference cell. More preferably, the periodic wavelength reference produces a sequence of wavelength calibrated timing pulses. Most preferably, each pulse corresponds to between about 0.4 pm and 50 pm wavelength increments.

In accordance with yet another aspect of the present invention, there is provided a method for measuring and adjusting a wavelength in an optical telecommunication system, comprising providing an input local oscillator, which is divided into two paths. The method further includes coupling the input local oscillator from the first path into a periodic wavelength reference, coupling the input local oscillator from the second path into a polarization scrambler for minimizing the polarization sensitivity of the technique and for depolarizing the local oscillator, wherein the periodic wavelength reference produces a real-time wavelength calibration clock for measuring a wavelength.

Preferably, the clock edges correspond to equally spaced optical frequency intervals used to trigger data acquisition in a detection circuit. Additionally, the local oscillator is mixed in a 3 dB optical coupler with an aggregate channel signal to be measured. More preferably, if the local oscillator is tuned to a frequency such that the heterodyne beat tones between the local oscillator and the input signal is within the detector bandwidth, the optical spectrum of the input signal is translated to an IF frequency determined by the heterodyne beat tones. Yet more preferably, there is provided a balanced detector coupled to the 3 dB optical coupler to cancel the intensity modulation of the input signal.

Most preferably, there is provided a low pass filter coupled between the 3 dB coupler and the balanced detector. Preferably, the polarization scrambler reduces DOP below about 10% for a 200 KHz bandwidth. Most preferably, there is provided an A/D converter coupled to the output of the periodic wavelength reference and the balanced detector.

### BRIEF DESCRIPTION OF THE DRAWINGS

For the purpose of illustrating aspects of the invention, the following drawings are presented, it being understood, however, that the aspects of the invention highlighted are not limited to the precise arrangements and instrumentalities shown, wherein:

FIG. 1 is a system architecture diagram of a wavelength monitor device based on polarization-diverse heterodyne detection with a tunable laser in accordance with one embodiment of the present invention;

FIGS. 2A-2D are graphical representation of optical spectrum of RZ signals without interfering tone at different spacing in accordance with one embodiment of the present invention;

FIG. 3 is a plot diagram of a line-width measurement of the RZ signal with 125 MHz electrical bandwidth;

FIG. 4 is a graph of differential accuracy of RZ signals without interfering tone at different spacing; and

FIG. 5 is a graph of absolute accuracy of RZ signals without interfering tone at different spacing.

### DETAILED DESCRIPTION

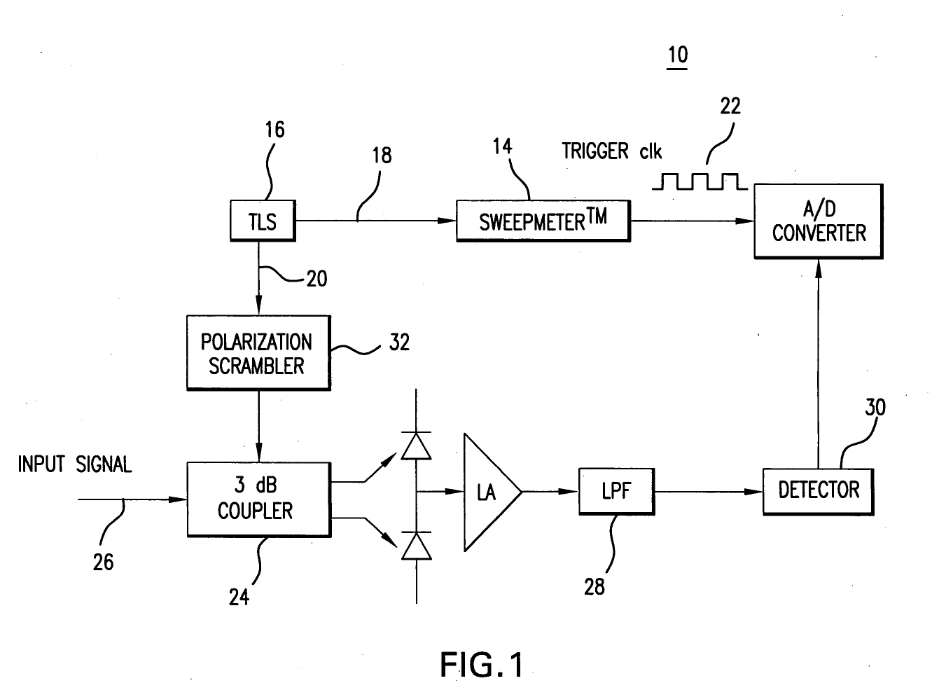

Referring now to the drawings wherein like numerals indicate like elements, there is provided a system architecture 10 as shown in FIG. 1. It is preferably composed of two subsystems: the optical heterodyne setup using an external cavity tunable laser source (TLS) 16 as a local oscillator (LO) and the Sweepmeter™ 14 for wavelength calibration of the LO; and a detection subsystem.

Most tunable lasers scan linearly with absolute wavelength accuracy of only about 10 to 50 pm. More preferably, to achieve relatively higher accuracy, a Sweepmeter™ developed by Precision Photonics Corp. for real-time wavelength calibration is used.

The Sweepmeter™ works by combining a periodic wavelength reference with a hydrogen cyanide (HCN) gas reference cell. The periodic wavelength reference produces a sequence of a digital clock, and one clock tick corresponds to about 0.4 pm wavelength increments. The clock tick can range from about 0.4 pm to about 50 pm. The HCN absorption spectrum, which is insensitive to ambient temperature (only about 0.01 pm/° C. temperature dependence), humidity and air pressure (not detectable), has about 0.5 pm absolute accuracy.

As shown in FIG. 1, light from the tunable laser source (TLS) 16 entering the Sweepmeter™ 14 via path 18 is divided into two paths (not shown). A first optical path couples light into a periodic wavelength reference; a second optical path couples light into an NIST-traceable HCN gas reference cell, both contained within the Sweepmeter™.

The periodic wavelength reference produces a real-time clock pulse 22. The clock pulse 22 edges correspond to equally space optical frequency intervals that are used to trigger data acquisition in the detection circuit. As the TLS 16 sweeps, two calibration numbers are provided from the Sweepmeter™ 14: 1) the optical frequency corresponding to the first output clock trigger, and 2) the optical frequency step size between clock outputs. The optical frequency axis of the measurement can thus be constructed with an accuracy of <1 pm rms, a resolution up to 0.4 pm (50 MHz), and a scan-to-scan repeatability of <0.2 pm rms. By calibrating the TLS 16 with the above method, a tunable LO with 0.4 pm optical frequency steps is produced. As discussed above, these steps can be as much as between 0.4 pm and 50 pm.

As shown in FIG. 1, the TLS is mixed via path 20 in a typical 3 dB optical coupler 24 with an aggregate channel signal to be measured. If the TLS (LO) is tuned to a frequency such that the heterodyne beat tones between the TLS (LO) and the input signal 26 is within the detector bandwidth (determined by the LPF 28), the optical spectrum of the input signal 26 is translated to an IF frequency determined by the heterodyne beating tone.

In addition to the IF heterodyne beating tone, the intensity modulation of the input signal 26 and the shot noise also fall into the IF bandwidth, and is treated as intensity noise.

In a preferred embodiment of an aspect of the invention, an optimum performance is achieved by using a balanced detector 30 to cancel the intensity modulation of the input signal 26. In this case, the dominant noise is the shot noise from the local oscillator (LO). By further reducing the detector bandwidth, the SNR can also be improved. However, the smallest electrical bandwidth may be limited by half of the optical frequency step so that the beating signal is present in at least one data acquisition clock.

To minimize the polarization sensitivity of the technique, a scheme for depolarizing TLS (LO) 16 using a polarization scrambler 32 is preferably used. This scrambler 32 is able to reduce DOP below 10% for a 200 KHz bandwidth, which is quite adequate for removing the unwanted effects associated with the polarization mismatch between the TLS 16 and the randomly polarized aggregate channel test signal.

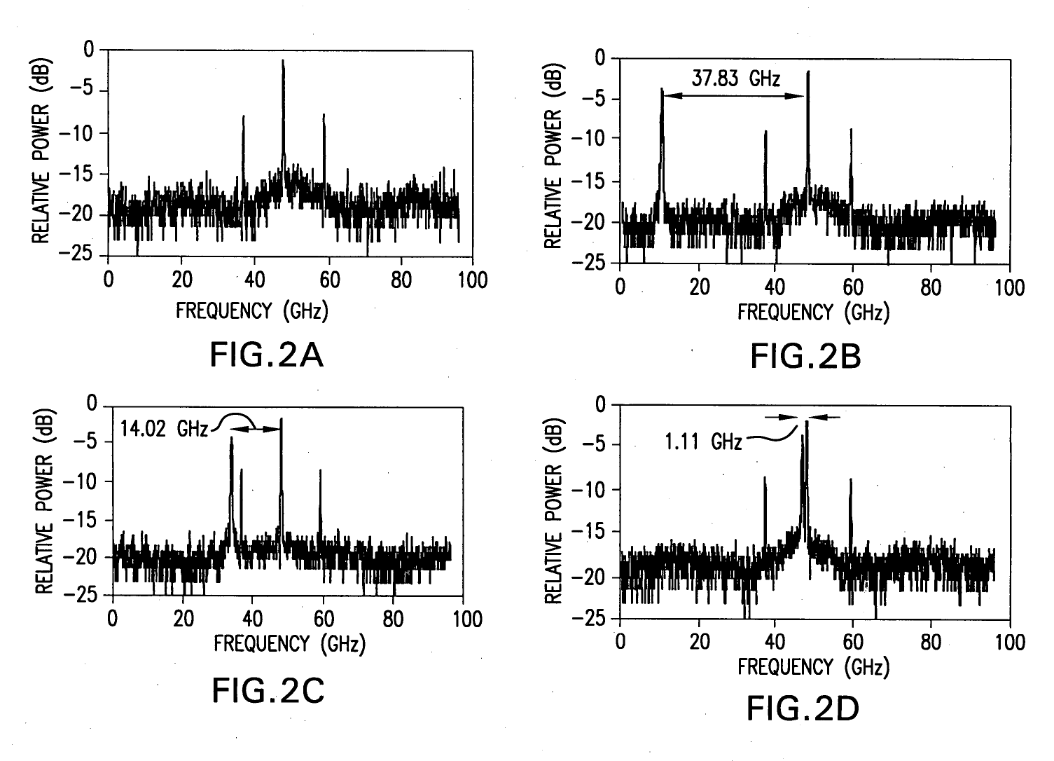

Turning now to FIGS. 2A-2D, where the measured optical spectrum of a RZ modulated signal using the heterodyne detection device and method of FIG. 1 is shown. Each optical spectrum represents a different condition. For example, FIG. 2A represents an RZ signal that is modulated with 2\hat{ }31 PRBS at an 11 Gb/s rate, and has a carrier-to-sideband ratio of about 7 dB. The remaining optical spectrums represent three additional conditions for testing wavelength accuracy by having neighboring CW tones at three different distances from the RZ signal. FIG. 2B shows a CW tone located at approximately 37.83 GHz, FIG. 2C shows a CW tone located at approximately 14.02 GHz and FIG. 2D shows a CW tone located at approximately 1.11 GHz, all from the center frequency of the RZ signal, respectively. In all three conditions, it is clear from the measured optical spectrums that the RZ signal is recoverable, despite the CW tones and their known effects of neighboring the RZ signal.

An appropriate low-pass filter 28 (25-50 MHz) may be used. Alternatively, one can use a New Focus O/E converter with a DC-125 MHz electrical bandwidth. While this non-optimal LPF reduces the wavelength measurement resolution, the interference tone is still spectrally resolved, appearing 1.11 GHz distance from the RZ carrier in FIG. 2(D).

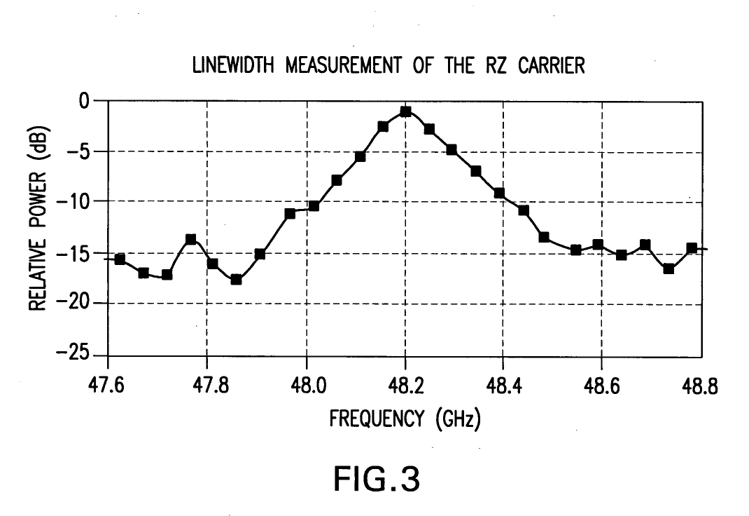

FIG. 3 shows an enlargement of the region around the RZ signal carrier. It illustrates the line-width broadening effect due to the insufficient resolution bandwidth. The measured line-width could be narrower if one uses a 50 MHz detector bandwidth. However, the center frequency of the RZ signal could still be estimated from the symmetric line shape of the measured data.

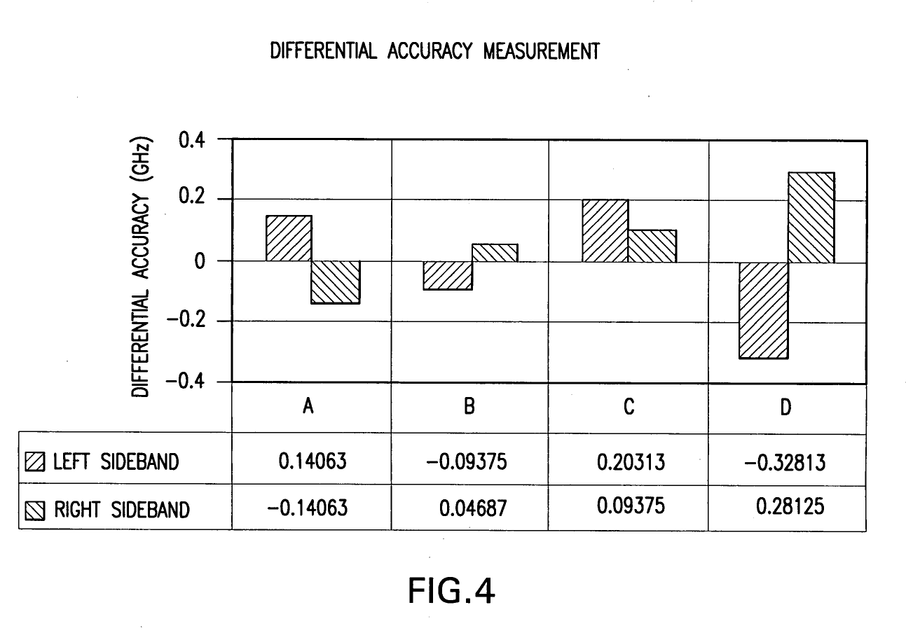

The differential accuracy is defined as the error in measuring the optical frequency difference between two signals. Because the optical frequency difference between the carrier and the RF sidebands of an RZ signal equals the RF clock frequency, a convenient approach to measuring the differential accuracy involves measuring the carrier to side band frequency difference. FIG. 4, for example, presents the measured differential accuracy obtained by evaluating the same RZ signal as in FIG. 3 in the presence of a CW interfering channel.

FIG. 4 shows the measured differential accuracy obtained by comparing the measured optical frequency difference between the RF sidebands and carrier with the RF clock frequency. In this particular example, the clock frequency is about 11 GHz. As can be seen from the data, the differential accuracy is about 0.1 GHz when the interfering CW tone is not present or is far away from the RZ signal (case A and B in FIG. 4).

When the CW tone is moved close to the left sideband of the RZ signal, the differential accuracy increases to 0.2 GHz (case C in FIG. 4). Finally, in case D, the distance between the CW tone and the RZ carrier is about 1 GHz. In this event, the differential accuracy degrades further to 0.3 GHz. The degradation of the differential accuracy by a close interfering channel is caused by the larger than desired detector bandwidth. By optimizing the detector bandwidth to 50 MHz, it is expected that uniform differential accuracy would result in the presence of any interfering tones.

In order to estimate the absolute accuracy of the heterodyne detection method herein described, the measured wavelength of a test tone is compared to that obtained from a Burleigh WA-7600 wavelength meter. The Burleigh WA-7600 wavelength meter has a specified 0.3 pm absolute and differential accuracy, and a ±0.2 ppm repeatability and is assumed to be well calibrated. The Burleigh WA-7600 has similar specifications to other commercially available wavelength meters. In each case, corresponding to the experimental conditions of FIG. 2(A) to FIG. 2(C), one would repeatedly measure 20 times the center wavelength of the RZ signal using either technique.

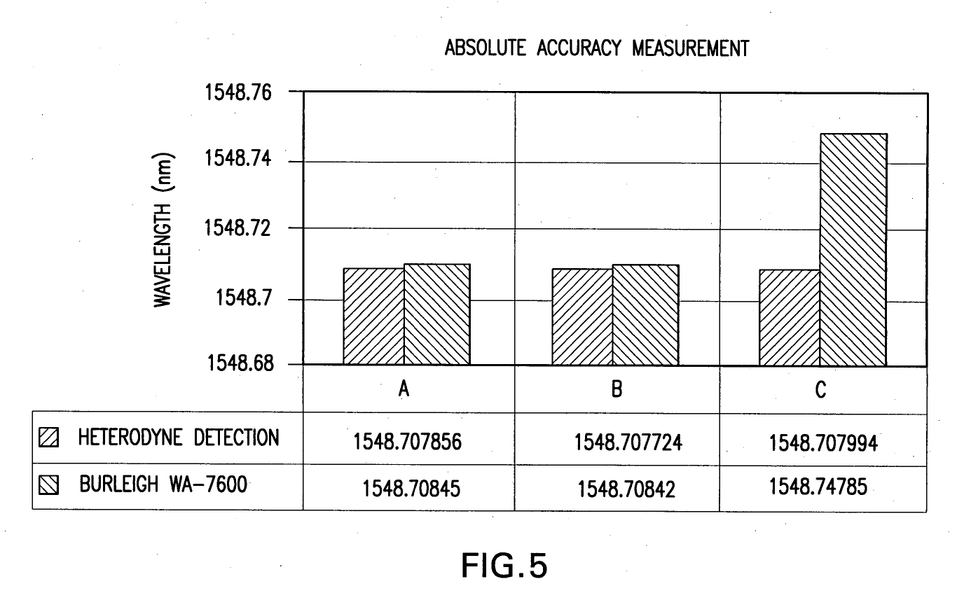

FIG. 5 shows a comparison of the average values of 20 measurements for each case (corresponding to FIG. 2(A) to FIG. 2(C)). The heterodyne detection method is substantially insensitive to the neighboring interfering channel while the Burleigh wavelength meter is extremely sensitive. This result may be explained by the fact that the Burleigh interferometric technique is not capable of resolving tones that are spaced closer than about 30 pm.

Thus, the Burleigh absolute accuracy is compromised by the presence of nearby interfering tones. An accurate estimate of the absolute accuracy of the Burleigh may be obtained only by comparing the average values for case A and case B (corresponding to FIG. 2(A) to FIG. 2(B)) when tones are no closer than approximately 37 GHz. In these two cases, the Burleigh wavelength meter meets its design specification of 0.3 pm absolute accuracy.

In FIG. 5, the difference between the average value obtained with the heterodyne detection method and the Burleigh wavelength meter (when comparing only cases A and B) is about 0.7 pm. Considering the 0.3 pm absolute accuracy of the Burleigh meter itself, the absolute accuracy of the heterodyne detection is about 1 pm on average.

Among the advantages of certain aspects of the present invention, a wavelength monitor scheme based on heterodyne detection with a real-time externally calibrated tunable laser provides for more accurate monitoring of optical signals, especially where channel spacing is less than about 35 GHz. The method and apparatus combine the high wavelength resolution characteristics provided by heterodyne detection with the high wavelength accuracy provided by a real-time calibrated tunable laser (using a HCN gas reference cell).

Aspects of the present invention provide a wavelength resolution (assuming a LPF of about 50 MHz) that is substantially advantageous to most commercially available wavelength meters (3 GHz) while attaining 1 pm absolute accuracy. Another important advantage results from the technique's insensitivity to environmental factors, test channel polarization and spectral content. This technique may be useful for deployment in frequency control apparatus required for future upgrades in long haul undersea telecommunications network.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A wavelength measure and control system for an optical telecommunication system, comprising:
a first portion comprising a heterodyne detection device having a real-time externally calibrated tunable laser source for use as a local oscillator to produce a periodic wavelength reference; and
a second portion that cooperates with the first portion for real-time wavelength calibration of an optical data signal.

2. The system of claim 1, wherein the second portion combines a periodic wavelength reference with a hydrogen cyanide (HCN) gas reference cell.

3. The system of claim 1, wherein the periodic wavelength reference produces a sequence of wavelength calibrated timing pulses.

4. The system of claim 3, wherein each pulse corresponds to between about 0.4 pm and 50 pm wavelength increments.

5. A method for measuring and adjusting a wavelength in an optical telecommunication system, comprising:
providing an input local oscillator, which is divided into two paths;
coupling the input local oscillator from the first path into a periodic wavelength reference;
coupling the input local oscillator from the second path into a polarization scrambler for minimizing the polarization sensitivity of the technique and for depolarizing the local oscillator;
wherein the periodic wavelength reference produces a real-time wavelength calibration clock for measuring a wavelength.

6. The method of claim 5, wherein the clock edges correspond to equally spaced optical frequency intervals that are used to trigger data acquisition in a detection circuit.

7. The method of claim 5, wherein the local oscillator is mixed in a 3 dB optical coupler with an aggregate channel signal to be measured.

8. The method of claim 7 wherein if the local oscillator is tuned to a frequency such that the heterodyne beat tones between the local oscillator and the input signal is within the detector bandwidth, the optical spectrum of the input signal is translated to an IF frequency determined by the heterodyne beat tones.

9. The method of claim 5, further comprising a balanced detector coupled to the 3 dB optical coupler to cancel the intensity modulation of the input signal.

10. The method of claim 9, further comprising a low pass filter coupled between the 3 dB coupler and the balanced detector.

11. The method of claim 10, wherein the polarization scrambler reduces DOP below about 10% for a 200 KHz bandwidth.

12. The method of claim 11, further providing an A/D converter coupled to the output of the periodic wavelength reference and the balanced detector.
